(19) United States
(12) Patent Application Publication
(10) Pub. No.: US 2011/0242078 A1
(43) Pub. Date: Oct. 6, 2011

(54) DISPLAY PANEL AND DISPLAY DEVICE PROVIDED WITH THIS

(75) Inventors: Isao Takahashi, Osaka (JP); Takahiro Yamaguchi, Osaka (JP); Shinya Takahashi, Osaka (JP); Noboru Matsuda, Osaka (JP)

(73) Assignee: Sharp Kabushiki Kaisha, Osaka-shi, Osaka (JP)

(21) Appl. No.: 12/998,859

(22) PCT Filed: Feb. 12, 2010
(86) PCT No.: PCT/JP2010/052023

§ 371 Date: Jun. 9, 2011

(30) Foreign Application Priority Data
May 15, 2009 (JP) 2009-118470

(51) Int. Cl. G09G 5/00

(52) U.S. Cl. 345/211

(57) ABSTRACT

In a display panel having no black matrix in a picture-frame region, occurrence of flicker in the picture-frame region is suppressed. On a substrate constituting a liquid crystal panel, a peripheral electrode is formed in such a way as to cover at least a part of an electrical wiring line arranged in a picture-frame region facing a counter electrode with a liquid crystal layer therebetween. Also, a voltage generating circuit for providing a predetermined potential to the peripheral electrode is provided in the liquid crystal panel. A control signal, which is a binary signal, is provided to the voltage generating circuit from an external source. The voltage generating circuit provides a potential having a predetermined potential difference from a potential provided to the counter electrode, or a potential equal to the potential provided to the counter electrode, to the peripheral electrode according to a value of the control signal.

### TECHNICAL FIELD

The present invention relates to a display panel, and more particularly to a technique for suppressing the occurrence of flicker in a display panel having no light-shielding layer in a picture-frame region.

### BACKGROUND ART

FIG. 9 is a cross-sectional view of a conventional general liquid crystal panel 901. As shown in FIG. 9, the liquid crystal panel 901 is composed of a TFT array substrate 930 and a color filter substrate 940 which are a pair of glass substrates. The liquid crystal panel 901 is sectioned into a display region which is a region for displaying an image, and a picture-frame region (non-display region) which is a region other than the display region. In the display region on the TFT array substrate 930 are formed pixel circuits including a TFT array, pixel electrodes 932, and so on. In the picture-frame region on the TFT array substrate 930 are formed electrical wiring lines 934 for driving the pixel circuits. On the other hand, the color filter substrate 940 has formed on its entire surface an electrode (hereinafter, referred to as the “counter electrode”) 942 for applying voltages according to an image to be displayed, between the pixel electrodes 932 and the electrode 942. Then, the TFT array substrate 930 and the color filter substrate 940 are bonded together with a sealing material 920, with a liquid crystal layer 950 being sandwiched therebetween. Meanwhile, in the conventional general liquid crystal panel 901, in order to prevent unwanted light leakage, a light-shielding layer called a black matrix 944 is formed on the color filter substrate 940. This black matrix 944 is formed in the picture-frame region and boundary portions between color filters of respective colors (e.g., between a red-colored layer and a green-colored layer).

Meanwhile, in recent years, there has been a case in which a liquid crystal panel that requires UV (Ultra Violet Ray) irradiation, such as a panel using PNLC (Polymer Network Liquid Crystal element), is adopted in a display device. In such a liquid crystal panel requiring UV irradiation, if a black matrix is provided in a picture-frame region, then sufficient UV irradiation is not performed in a boundary portion between a display region and the picture-frame region, causing degradation in display quality (e.g., peripheral nonuniformity). Hence, as shown in FIG. 10, a liquid crystal panel 902 requiring UV irradiation is not provided with a black matrix.

Note that, in connection with the invention of the present application, Japanese Patent No. 2959123 discloses an invention of a liquid crystal display device 903 that prevents application of a direct-current voltage to a liquid crystal layer by providing an electrode (peripheral electrode) 910 around a display region 905 as shown in FIG. 11 in a planar view and making the potential of the peripheral electrode 910 equal to the potential of a counter electrode (hereinafter, referred to as the “counter potential”).

### PRIOR ART DOCUMENTS

### Patent Documents

[Patent Document 1] Japanese Patent No. 2959123

### SUMMARY OF THE INVENTION

### Problems to be Solved by the Invention

However, in a liquid crystal panel requiring UV irradiation, i.e., a liquid crystal panel having no black matrix in a picture-frame region, flicker may be visually recognized in the picture-frame region. This will be described below. FIG. 12 is a plan view showing a schematic configuration of a liquid crystal panel 902 having no black matrix in a picture-frame region. In an example shown in FIG. 12, a TFT array substrate 930 and a color filter substrate 940 smaller in size than the TFT array substrate 930 are bonded together, and a substantially central portion of a region where the color filter substrate 940 is disposed is a display region 905. In a picture-frame region which is a peripheral region of the display region 905, for example, as shown in FIG. 12, electrical wiring lines 934 for driving pixel circuits in the display region 905 are formed.

Here, when taking a look at a given electrical wiring line 934, if the electrical wiring line 934 is a power supply wiring line, then, for example, a potential of 0 V is continuously provided to the electrical wiring line 934. On the other hand, to a counter electrode 942 on the color filter substrate 940 are alternately provided, for example, a potential of 0 V and a potential of 5 V every horizontal scanning period. At this time, in the picture-frame region, a voltage of 0 V and a voltage of 5 V are alternately applied between the counter electrode 942 and the electrical wiring lines 934 (see reference numeral 96 in FIG. 10) every horizontal scanning period. As a result, the transmittance of the panel changes every horizontal scanning period, and accordingly, flicker is visually recognized in a region indicated by reference numeral 97 in FIG. 12. Meanwhile, the liquid crystal panel is sectioned into a display region and a picture-frame region as shown in FIG. 13A, and in general the picture-frame region is covered by a casing as shown in FIG. 13B. Hence, it is considered that the occurrence of flicker in the picture-frame region is not problematic. However, when a viewer views the liquid crystal panel in oblique directions, as indicated by reference numeral 98 in FIG. 13C, flicker in the picture-frame region is visually recognized.

In the liquid crystal display device 903 disclosed in the above-described Japanese Patent No. 2959123, as shown in FIG. 11, a black matrix 944 is formed around the display region 905. Hence, this technique is not applied to the liquid crystal panel 902 having no black matrix in the picture-frame region. Note that a potential provided to the peripheral electrode 910 is equal to the counter potential and is not configured such that any potential is provided.

Furthermore, in the liquid crystal panel 901 having the black matrix 944 (see FIG. 9), since light is shielded by the black matrix 944, the color of the picture-frame region cannot be set to an optional color (e.g., cannot be set according to the type of application), lacking in designability.

An object of the present invention is therefore to suppress the occurrence of flicker in a picture-frame region of a display panel having no black matrix in the picture-frame region. Another object of the present invention is to provide a display panel with excellent designability in a picture-frame region.

### Means for Solving the Problems

A first aspect of the present invention is directed to a display panel that comprises a display region for displaying an image and a picture-frame region which is a peripheral region of the display region, and that has at least one substrate, a display element, a first electrode provided in the display region on the substrate to display an image, and a second electrode disposed to face the first electrode with the display element interposed therebetween, to apply a voltage according to an image to be displayed between the first electrode and the second electrode, the display panel comprising:

a peripheral electrode formed in the picture-frame region on the substrate in such a way as to cover at least a part of an electrical wiring line arranged in the picture-frame region on the substrate, the electrical wiring line being arranged in such a way as to face the second electrode with the display element interposed therebetween, the peripheral electrode being formed to face the electrical wiring line with an insulating film interposed between; and

a peripheral-electrode-giving-potential generating circuit that provides a potential to the peripheral electrode, the potential being determined according to a control signal provided from an external source, wherein

a light-shielding layer is not provided in the picture-frame region.

According to a second aspect of the present invention, in the first aspect of the present invention,

the peripheral electrode is formed in the picture-frame region on the substrate in such a way as to surround the display region.

According to a third aspect of the present invention, in the first aspect of the present invention,

the peripheral electrode is formed in such a way as to cover all of the electrical wiring line.

According to a fourth aspect of the present invention, in the first aspect of the present invention,

the control signal is a binary signal, and

the peripheral-electrode-giving-potential generating circuit provides a potential having a predetermined potential difference from a potential provided to the second electrode, or a potential equal to the potential provided to the second electrode, to the peripheral electrode according to a value of the control signal.

According to a fifth aspect of the present invention, in the fourth aspect of the present invention,

a first potential and a second potential are alternately provided to the second electrode every predetermined period, the first potential being a predetermined high-level potential and the second potential being a predetermined low-level potential, and

the peripheral-electrode-giving-potential generating circuit:
receives a first peripheral electrode potential setting signal having a potential equal to the second potential when the first potential is provided to the second electrode, and having a potential equal to the first potential when the second potential is provided to the second electrode; and a second peripheral electrode potential setting signal having a potential equal to the first potential when the first potential is provided to the second electrode, and having a potential equal to the second potential when the second potential is provided to the second electrode, and
provides the first peripheral electrode potential setting signal or the second peripheral electrode potential setting signal to the peripheral electrode according to the value of the control signal.

According to a sixth aspect of the present invention, in the first aspect of the present invention,

the first electrode is a pixel electrode to which a potential according to the image to be displayed is provided, the second electrode is a counter electrode provided to apply a voltage between the pixel electrode and the second electrode, and the display element is a liquid crystal element.

According to a seventh aspect of the present invention, in the first aspect of the present invention,

the first electrode is an anode electrode, the second electrode is a cathode electrode, and the display element is an organic electroluminescence element.

An eighth aspect of the present invention is directed to a display device comprising a display panel according to any one of the first through the seventh aspects of the present invention.

### Effects of the Invention

According to the first aspect of the present invention, a peripheral electrode is formed in a picture-frame region on a substrate composing a display panel, in such a way as to cover an electrical wiring line. In addition, peripheral-electrode-giving-potential generating circuit that provides a predetermined potential to the peripheral electrode is provided in the display panel. A potential provided to the peripheral electrode is determined according to a control signal provided to the peripheral-electrode-giving-potential generating circuit from an external source. Hence, for example, a potential can be provided to the peripheral electrode such that the voltage between a second electrode and the peripheral electrode is constant. By this, in a region of the picture-frame region where the peripheral electrode is formed, a constant voltage is applied to a display element during the operation of the display panel. As a result, the occurrence of flicker in the picture-frame region caused by variations in applied voltage to the display element is suppressed.

According to the second aspect of the present invention, since the peripheral electrode is formed in such a way as to surround a display region, while the outer area of the display region is allowed to have the same color (uniform color), the occurrence of flicker in the picture-frame region can be suppressed.

According to the third aspect of the present invention, since the peripheral electrode is formed in such a way as to cover all of the electrical wiring line, the occurrence of, flicker in the picture-frame region caused by variations in applied voltage to the display element can be reliably prevented.

According to the fourth aspect of the present invention, a potential having a predetermined potential difference from a potential of the second electrode, or a potential equal to the potential of the second electrode is provided to the peripheral electrode according to the value of the control signal provided to the peripheral-electrode-giving-potential generating circuit. Hence, by changing the value of the control signal, the magnitude of a voltage applied between the second electrode and the peripheral electrode can be changed. In other words, the color of the picture-frame region can be set to different colors as necessary. By this, a display panel is implemented that is superior in designability to conventional ones, while suppressing the occurrence of flicker in the picture-frame region.

According to the fifth aspect of the present invention, a potential for black display or a potential for white display is provided to the peripheral electrode according to the value of the control signal provided to the peripheral-electrode-giving-potential generating circuit. Hence, the color of the picture-frame region can be appropriately set to black or white. By this, as with the fourth aspect of the present invention, a display panel is implemented that is superior in designability to conventional ones, while suppressing the occurrence of flicker in the picture-frame region.

According to the sixth aspect of the present invention, a liquid crystal panel that provides the same effect as that obtained in the first aspect of the present invention is implemented.

According to the seventh aspect of the present invention, an organic EL panel that provides the same effect as that obtained in the first aspect of the present invention is implemented.

According to the eighth aspect of the present invention, a display device including a display panel that provides the same effect as that obtained in any of the first to seventh aspects of the present invention is implemented.

### BRIEF DESCRIPTION OF THE DRAWINGS

FIG. 1 is a plan view showing a schematic configuration of a liquid crystal panel according to an embodiment of the present invention.

FIG. 2 is a cross-sectional view of the liquid crystal panel according to the embodiment.

FIG. 3 is a cross-sectional view of a region indicated by reference numeral 51 in FIG. 1, taken along line A-A of FIG. 2 in the embodiment.

FIG. 4 is a logic circuit diagram showing a configuration of a voltage generating circuit in the embodiment.

FIG. 5A to FIG. 5C are signal waveform diagrams for describing the operation of the voltage generating circuit in the embodiment.

FIG. 6 is a diagram showing an example where a black potential is provided to a peripheral electrode in the embodiment.

FIG. 7 is a diagram showing an example where a white potential is provided to the peripheral electrode in the embodiment.

FIG. 8 is a cross-sectional view showing a schematic configuration of a general organic EL panel.

FIG. 9 is a cross-sectional view of a conventional general liquid crystal panel.

FIG. 10 is a cross-sectional view of a liquid crystal panel having no black matrix in a conventional example.

FIG. 11 is a plan view showing a schematic configuration of a liquid crystal display device disclosed in Japanese Patent No. 2959123.

FIG. 12 is a plan view showing a schematic configuration of the liquid crystal panel having no black matrix in the conventional example.

FIGS. 13A to 13C are diagrams for describing flicker in a picture-frame region in the conventional example.

### MODE FOR CARRYING OUT THE INVENTION

An embodiment of the present invention will be described below with reference to the accompanying drawings.

<1. Configuration of a Liquid Crystal Panel>

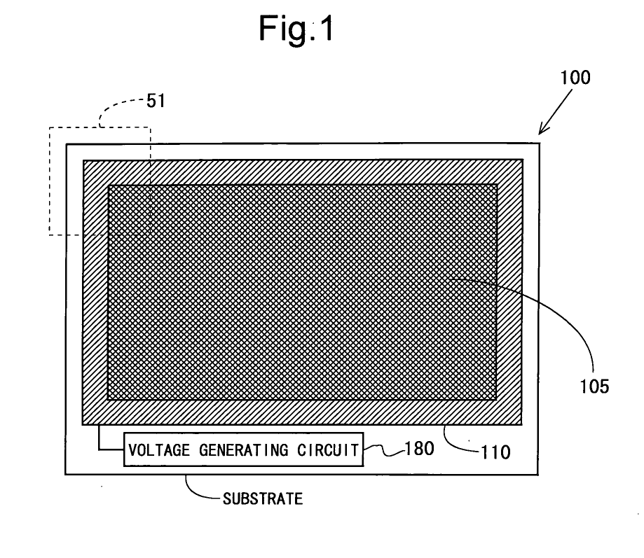

FIG. 1 is a plan view showing a schematic configuration of a liquid crystal panel 100 according to an embodiment of the present invention. The liquid crystal panel 100 includes a display region 105 which is a region for displaying an image, and a picture-frame region (non-display region) which is a region other than the display region. In the present embodiment, as shown in FIG. 1 in a planar view, in the picture-frame region, an electrode (hereinafter, referred to as the “peripheral electrode”) 110 is formed to surround the display region 105. In addition, a voltage generating circuit 180 for providing a predetermined potential to the peripheral electrode 110 is provided in the picture-frame region of the liquid crystal panel 100. Note that in the following description it is assumed that the display mode of the liquid crystal panel 100 is a normally white mode. Note also that it is assumed that black display is performed when the liquid crystal applied voltage is 5 V, and white display is performed when the liquid crystal applied voltage is 0 V.

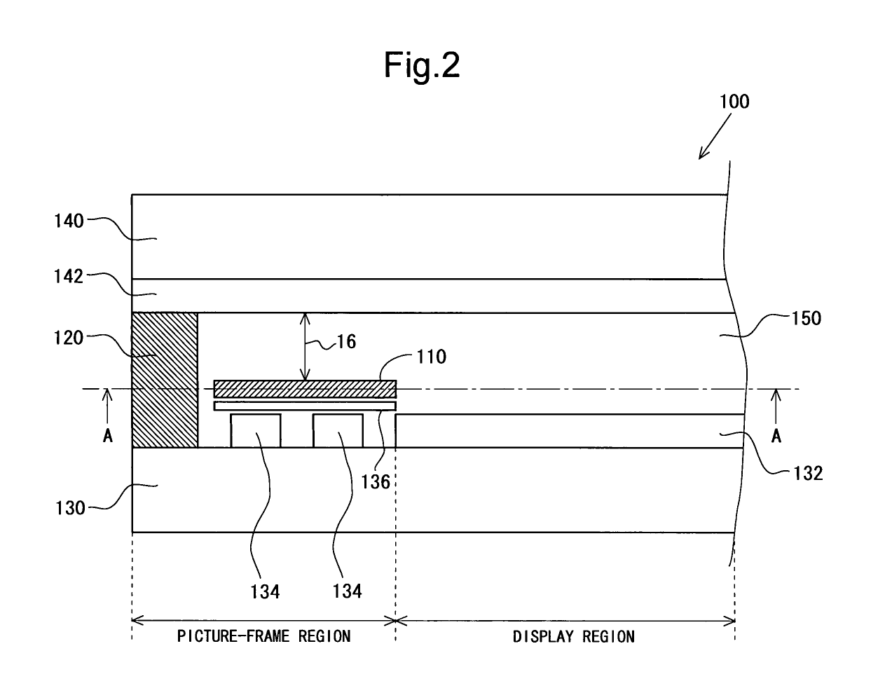

FIG. 2 is a cross-sectional view of the liquid crystal panel 100 according to the present embodiment. The liquid crystal panel 100 is composed of a TFT array substrate 130 and a color filter substrate 140 which are a pair of glass substrates. In the display region of the TFT array substrate 130A are formed pixel circuits including a TFT array, pixel electrodes 132, and so on. Electrical wiring lines 134 for driving the pixel circuits are formed in the picture-frame region of the TFT array substrate 130. On the other hand, the color filter substrate 140 has formed on its entire surface a counter electrode 142 for applying voltages, between the pixel electrodes 132 and the counter electrode 142, according to an image to be displayed. Then, the TFT array substrate 130 and the color filter substrate 140 are bonded together with a sealing material 120, with a liquid crystal layer 150 being sandwiched therebetween.

Meanwhile, in the present embodiment, as a display element, the above-described PNLC (Polymer Network Liquid Crystal element) is adopted. Hence, a black matrix serving as a light-shielding layer is not provided in the liquid crystal panel 100 according to the present embodiment. On the other hand, in the picture-frame region on the TFT array substrate 130 is formed the above-described peripheral electrode 110 in such a way as to cover the electrical wiring lines 134. Note that an insulating film 136 is provided between the peripheral electrode 110 and the electrical wiring lines 134 to provide an electrically nonconducting state therebetween.

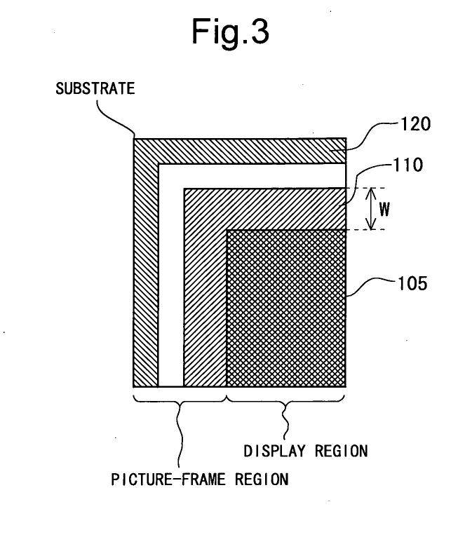

FIG. 3 is a cross-sectional view of a region indicated by reference numeral 51 in FIG. 1, taken along line A-A of FIG. 2. As shown in FIG. 3, the peripheral electrode 110 is formed on the more circumferential edge side (of the substrate) than an outer edge of the display region 105, and the sealing material 120 is provided on the more circumferential edge side than the peripheral electrode 110, with a little gap therebetween. The width W of the peripheral electrode 110 is generally 1 to 2 millimeters.

Note that the voltage generating circuit 180 may be provided on the inner side than the sealing material 120 or may be provided on the outer side than the sealing material 120. Note, however, that in the case of a configuration in which the voltage generating circuit 180 is provided on the inner side than the sealing material 120, it is preferable that the peripheral electrode 110 be formed in such a way as to cover not only the electrical wiring lines 134 but also the voltage generating circuit 180.

In a configuration such as that described above, in the display region 105, voltages corresponding to potential differences between the potentials of the pixel electrodes 132 and the potential of the counter electrode 142 are applied to the liquid crystal layer 150, whereby display according to the voltages is performed. On the other hand, in the picture-frame region, a voltage corresponding to a potential difference between the potential of the peripheral electrode 110 and the potential of the counter electrode 142 is applied to the liquid crystal layer 150, whereby display according to the voltage is performed.

Note that, in the present embodiment, a first electrode is implemented by the pixel electrode 132, a second electrode is implemented by the counter electrode 142, and a peripheral-electrode-giving-potential generating circuit is implemented by the voltage generating circuit 180.

<2. Configuration and Operation of the Voltage Generating Circuit>

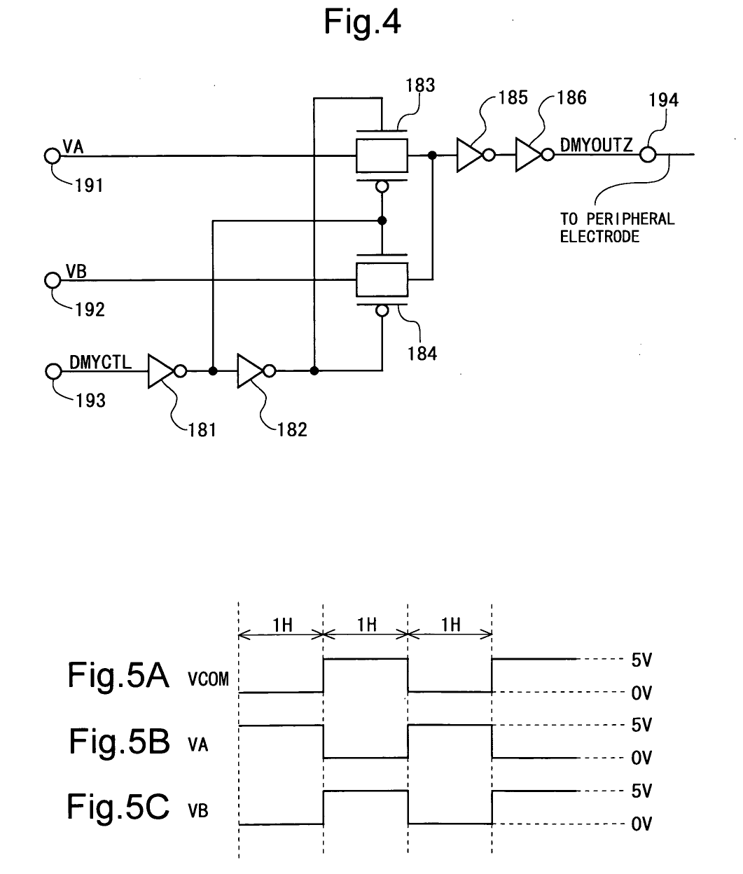

FIG. 4 is a logic circuit diagram showing a configuration of the voltage generating circuit 180. As shown in FIG. 4, the voltage generating circuit 180 includes four inverters 181, 182, 185, and 186; and CMOS switches 183 and 184, each composed of a P-type TFT and an N-type TFT. In addition, the voltage generating circuit 180 has three input terminals 191, 192, and 193 and one output terminal 194. Note that in the following the input terminal 191 is referred to as the “first input terminal”, the input terminal 192 is referred to as the “second input terminal”, the input terminal 193 is referred to as the “third input terminal”, and the output terminal 194 is referred to as the “first output terminal”.

Connection relationships between the components in the voltage generating circuit 180 are as follows. As for the inverter 181, the input terminal is connected to the third input terminal 193, and has the output terminal is connected to the input terminal of the inverter 182, the gate terminal of the P-type TFT of the CMOS switch 183, and the gate terminal of the N-type TFT of the CMOS switch 184. As for the inverter 182, the input terminal is connected to the output terminal of the inverter 181, the gate terminal of the P-type TFT of the CMOS switch 183, and the gate terminal of the N-type TFT of the CMOS switch 184, and the output terminal is connected to the gate terminal of the N-type TFT of the CMOS switch 183 and the gate terminal of the P-type TFT of the CMOS switch 184.

As for the CMOS switch 183, the input terminal is connected to the first input terminal 191, the output terminal is connected to the input terminal of the inverter 185 and the output terminal of the CMOS switch 184, the gate terminal of the N-type TFT is connected to the output terminal of the inverter 182 and the gate terminal of the P-type TFT of the CMOS switch 184, and the gate terminal of the P-type TFT is connected to the output terminal of the inverter 181, the input terminal of the inverter 182, and the gate terminal of the N-type TFT of the CMOS switch 184. As for the CMOS switch 184, the input terminal is connected to the second input terminal 192, the output terminal is connected to the input terminal of the inverter 185 and the output terminal of the CMOS switch 183, the gate terminal of the N-type TFT is connected to the output terminal of the inverter 181, the input terminal of the inverter 182, and the gate terminal of the P-type TFT of the CMOS switch 183, and the gate terminal of the P-type TFT is connected to the output terminal of the inverter 182 and the gate terminal of the N-type TFT of the CMOS switch 183.

As for the inverter 185, the input terminal is connected to the output terminal of the CMOS switch 183 and the output terminal of the CMOS switch 184, and the output terminal is connected to the input terminal of the inverter 186. As for the inverter 186, the input terminal is connected to the output terminal of the inverter 185, and the output terminal is connected to the first output terminal 194. Note that the first output terminal 194 is connected to the peripheral electrode 110.

In a configuration such as that described above, signals VA and VB of potentials to be provided to the peripheral electrode 110 are provided to the first input terminal 191 and the second input terminal 192. Note that in the following the signal VA provided to the first input terminal 191 is referred to as the “first peripheral electrode potential setting signal” and the signal VB provided to the second input terminal 192 is referred to as the “second peripheral electrode potential setting signal”. To the third input terminal 193 is provided a control signal DMYCTL for controlling a potential provided to the peripheral electrode 110. A signal of a potential provided to the peripheral electrode 110 is outputted from the first output terminal 194 as an output signal DMYOUTZ.

Next, the operation of the voltage generating circuit 180 will be described. FIG. 5A to FIG. 5C are signal waveform diagrams for describing the operation of the voltage generating circuit 180. FIG. 5A shows a waveform of a counter electrode drive signal VCOM for driving the counter electrode 142. FIG. 5B shows a waveform of the first peripheral electrode potential setting signal VA. FIG. 5C shows a waveform of the second peripheral electrode potential setting signal VB. As understood from the waveform of the counter electrode drive signal VCOM shown in FIG. 5A, a potential of 0 V and a potential of 5 V are alternately provided to the counter electrode 142 every horizontal scanning period (1H). For the first peripheral electrode potential setting signal VA, as shown in FIG. 5B, a potential of 5 V and a potential of 0 V are alternately repeated every horizontal scanning period (1H) such that a potential different than the counter potential is provided. For the second peripheral electrode potential setting signal VB, as shown in FIG. 5C, a potential of 0 V and a potential of 5 V are alternately repeated every horizontal scanning period (1H) such that the same potential as the counter potential is provided. Note that in the present embodiment 5V corresponds to a first potential and 0 V corresponds to a second potential.

Here, when the logic level of the control signal DMYCTL provided to the voltage generating circuit 180 is set to a high level, a low-level signal is outputted from the output terminal of the inverter 181 and a high-level signal is outputted from the output terminal of the inverter 182. By this, the CMOS switch 183 is placed in an on state and the CMOS switch 184 is placed in an off state. As a result, the first peripheral electrode potential setting signal VA is provided to the input terminal of the inverter 185. The signal provided to the input terminal of the inverter 185 is inverted by the inverter 185 and is further inverted by the inverter 186. Accordingly, the potential of an output signal DMYOUTZ becomes the potential of the first peripheral electrode potential setting signal VA. In other words, the potential of the first peripheral electrode potential setting signal VA is provided to the peripheral electrode 110. By this, as understood from FIG. 5A and FIG. 5B, a voltage of 5 V is continuously applied between the counter electrode 142 and the peripheral electrode 110. As a result, in a region of the picture-frame region where the peripheral electrode 110 is formed, black display is performed.

On the other hand, when the logic level of the control signal DMYCTL provided to the voltage generating circuit 180 is set to a low level, a high-level signal is outputted from the output terminal of the inverter 181 and a low-level signal is outputted from the output terminal of the inverter 182. By this, the CMOS switch 183 is placed in an off state and the CMOS switch 184 is placed in an on state. As a result, the second peripheral electrode potential setting signal VB is provided to the input terminal of the inverter 185. The signal provided to the input terminal of the inverter 185 is inverted by the inverter 185 and is further inverted by the inverter 186. Accordingly, the potential of an output signal DMYOUTZ becomes the potential of the second peripheral electrode potential setting signal VB. In other words, the potential of the second peripheral electrode potential setting signal VB is provided to the peripheral electrode 110. By this, as understood from FIG. 5A and FIG. 5C, a voltage of 0 V is continuously applied between the counter electrode 142 and the peripheral electrode 110. As a result, in a region of the picture-frame region where the peripheral electrode 110 is formed, white display is performed.

<3. Effects>

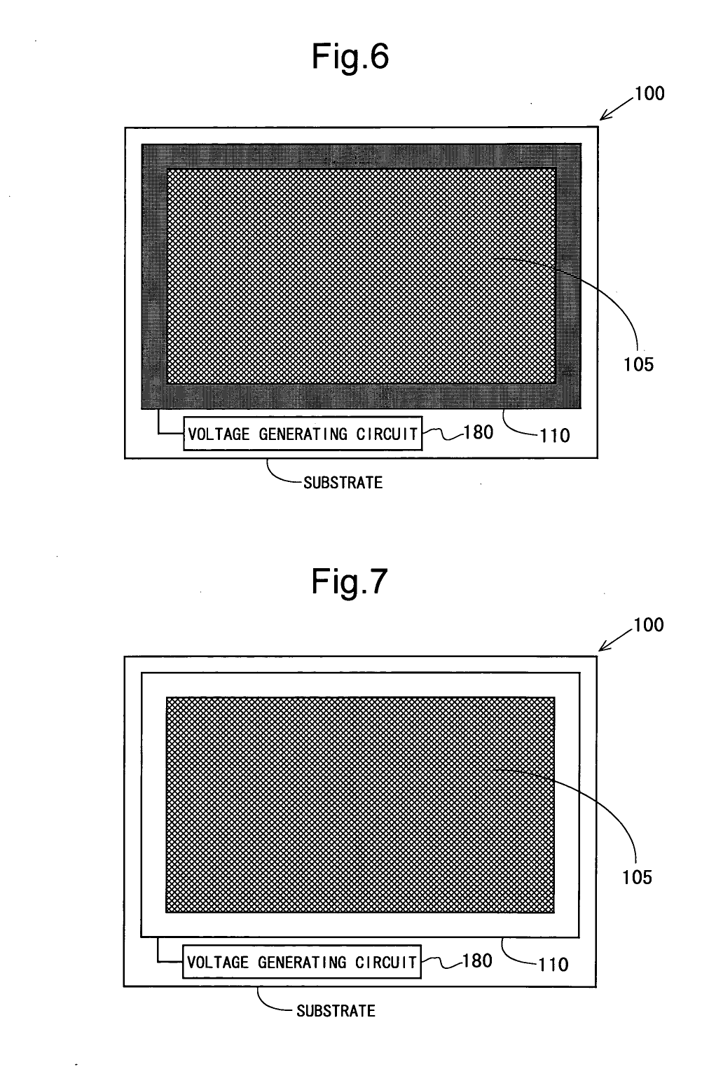

According to the present embodiment, the peripheral electrode 110 is formed in the picture-frame region on the TFT array substrate 130 composing the liquid crystal panel 100, in such a way as to cover the electrical wiring lines 134. In addition, the voltage generating circuit 180 for providing a predetermined potential to the peripheral electrode 110 is provided in the liquid crystal panel 100. To the peripheral electrode 110 is provided a potential equal to a counter potential or a potential reverse to the counter potential, according to a control signal DMYCTL provided to the voltage generating circuit 180 from an external source. Note that the “potential reverse to the counter potential” refers to a potential which has a polarity reverse to that of the counter potential with respect to a predetermined reference potential (2.5 V in an example shown in FIG. 5A), and where a voltage between the potential and the reference potential is equal to a voltage between the reference potential and the counter potential. In the present embodiment, when the logic level of the control signal DMYCTL is set to a high level, a potential reverse to the counter potential is continuously provided to the peripheral electrode 110. At this time, in the picture-frame region, the voltage applied between the counter electrode 142 and the peripheral electrode 110 (see reference numeral 16 in FIG. 2) is 5 V. As a result, in a region of the picture-frame region where the peripheral electrode 110 is formed, black display is performed as shown in FIG. 6. On the other hand, when the logic level of the control signal DMYCTL is set to a low level, a potential equal to the counter potential is continuously provided to the peripheral electrode 110. At this time, in the picture-frame region, the voltage applied between the counter electrode 142 and the peripheral electrode 110 is 0 V. As a result, in a region of the picture-frame region where the peripheral electrode 110 is formed, white display is performed as shown in FIG. 7. In the above-described manner, during the operation of the liquid crystal panel 100, in a region of the picture-frame region where the peripheral electrode 110 is formed, a constant voltage is applied to the liquid crystal layer 150. Hence, the occurrence of flicker in the picture-frame region caused by variations in liquid crystal applied voltage is prevented.

Note that, in the case in which the display mode of the liquid crystal panel 100 is a normally black mode, when the logic level of a control signal DMYCTL provided to the voltage generating circuit 180 is set to a high level, white display is performed in the picture-frame region, and when the logic level of the control signal DMYCTL is set to a low level, black display is performed in the picture-frame region.

According to the present, embodiment, by changing the logic level of a control signal DMYCTL provided to the voltage generating circuit 180, the color of the picture-frame region can be set to black or can be set to white. As such, the liquid crystal panel 100 which is also superior in terms of design to conventional ones is implemented. Note that, in the voltage generating circuit 180 shown in FIG. 4, by appropriately setting the potential level of a signal outputted from the inverter 186 (e.g., by setting the high-level side to 4 V and the low-level side to 1 V), grayscale display can be performed. Furthermore, by providing color filters in the picture-frame region on the color filter substrate 140, color grayscale display can be performed.

<4. Variant>

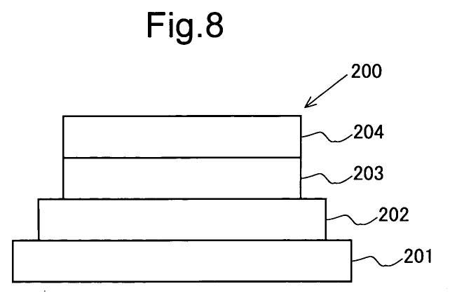

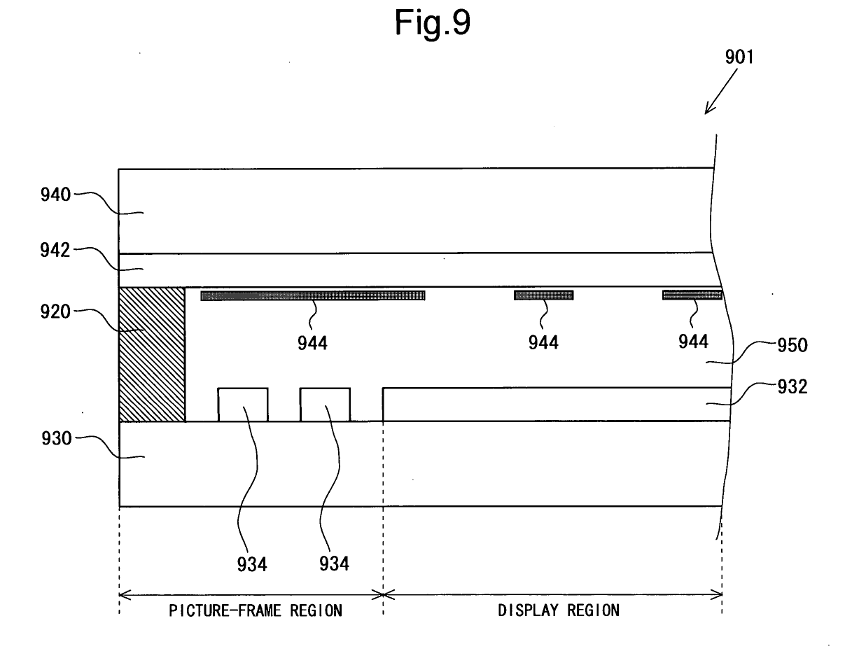

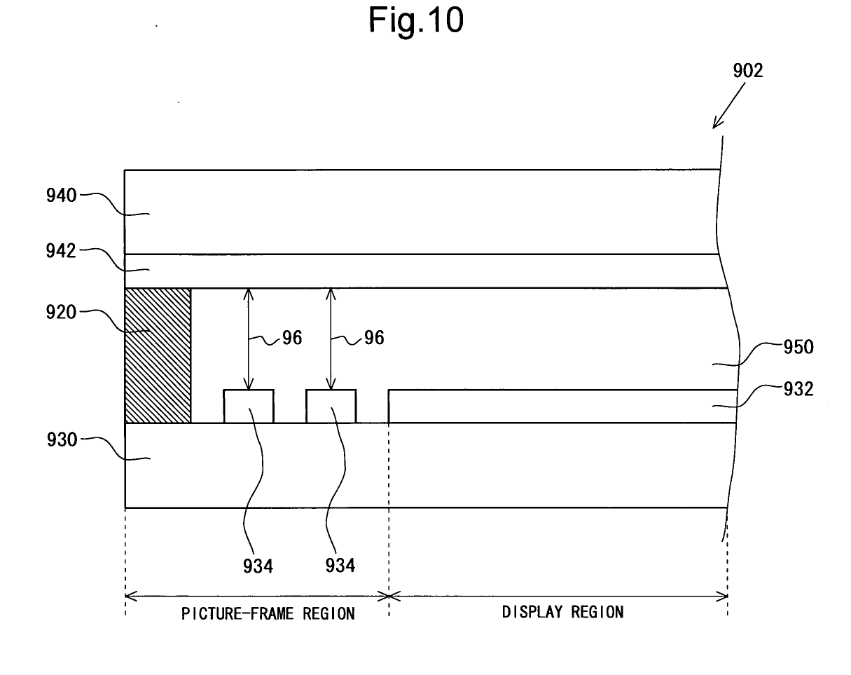

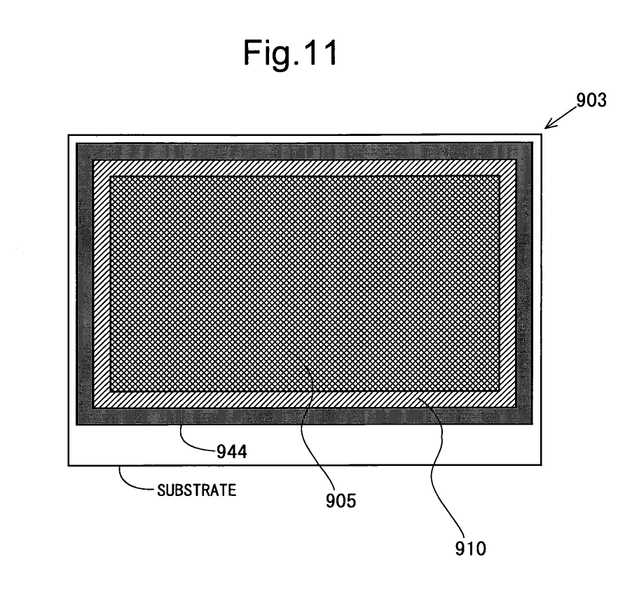

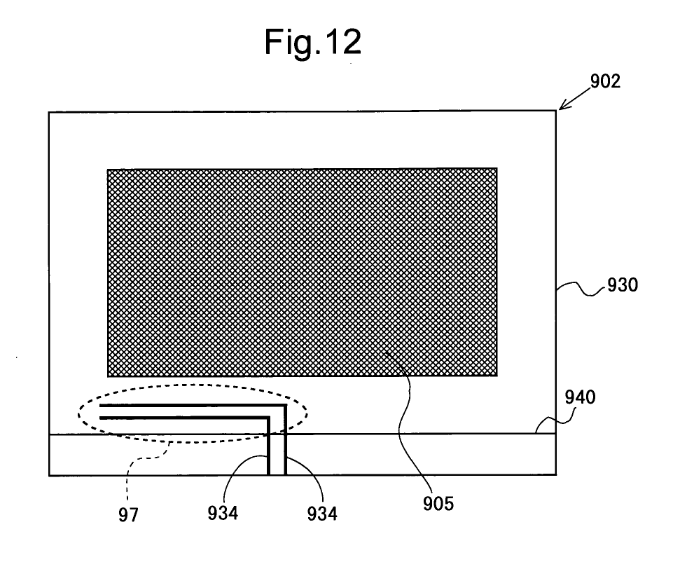

Although, in the above-described embodiment, description is made using a liquid crystal panel as an example of a display panel, the present invention is not limited thereto and the present invention can also be applied to an organic EL panel using an organic electroluminescence element, which will be described with reference to FIG. 8. FIG. 8 is a cross-sectional view showing a schematic configuration of a general organic EL panel 200. As shown in FIG. 8, the organic EL panel 200 is composed of a glass substrate 201, an anode electrode 202 which is a transparent electrode formed on the glass substrate 201, a cathode electrode 204 which is a metal electrode, and a light-emitting layer 203 stacked between the anode electrode 202 and the cathode electrode 204. In such a configuration, light emission is performed by a current flowing through the light-emitting layer 203 according to the magnitude of a voltage applied between the anode electrode 202 and the cathode electrode 204. Therefore, when an organic EL panel is adopted as a display panel, a first electrode is implemented by an anode electrode and a second electrode is implemented by a cathode electrode.

<5. Others>

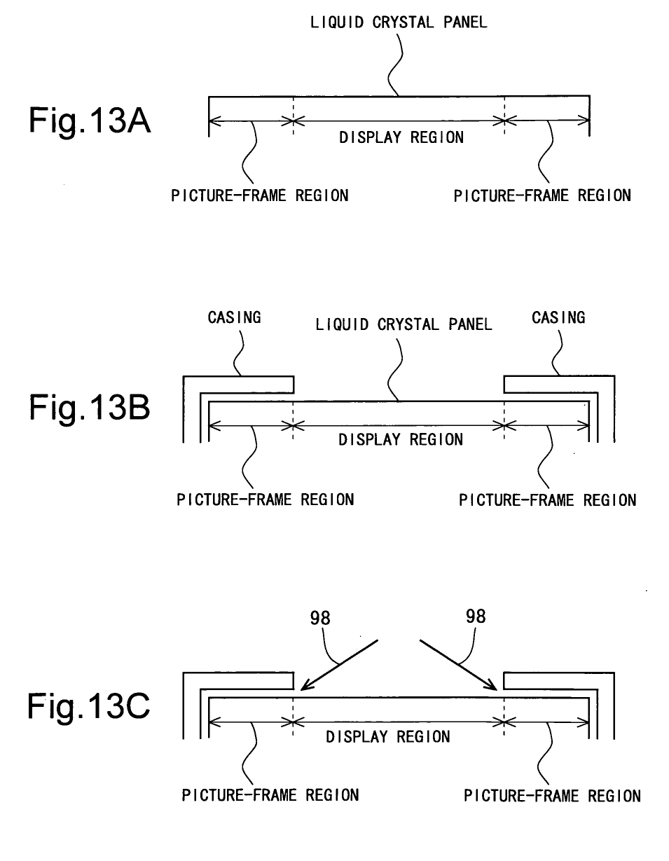

Although in the above-described embodiment the peripheral electrode 110 is formed in such away as to surround the display region 105, the present invention is not limited thereto. For example, when electrical wiring lines 134 are formed only in picture-frame regions of two sides among picture-frame regions of four sides surrounding the display region 105, the configuration may be such that a peripheral electrode 110 is provided only in the picture-frame regions of two sides where the electrical wiring lines 134 are formed. In addition, the peripheral electrode 110 does not necessarily need to be formed in such a way as to coverall of the electrical wiring lines 134. For example, the peripheral electrode 110 does not need to be formed on those electrical wiring lines 134 formed at a location where flicker is not visually recognized even if a viewer views the liquid crystal panel 100 in oblique directions as shown in FIG. 13C.

### DESCRIPTION OF REFERENCE NUMERALS

100: LIQUID CRYSTAL PANEL
105: DISPLAY REGION
110: PERIPHERAL ELECTRODE
120: SEALING MATERIAL
130: TFT ARRAY SUBSTRATE
132: PIXEL ELECTRODE
134: ELECTRICAL WIRING LINE
136: INSULATING FILM
140: COLOR FILTER SUBSTRATE
142: COUNTER ELECTRODE
150: LIQUID CRYSTAL LAYER
180: VOLTAGE GENERATING CIRCUIT
181, 182, 185, and 186: INVERTER
183 and 184: CMOS SWITCH
200: ORGANIC EL PANEL
201: GLASS SUBSTRATE
202: ANODE ELECTRODE
203: LIGHT-EMITTING LAYER
204: CATHODE ELECTRODE

1. A display panel that comprises a display region for displaying an image and a picture-frame region which is a peripheral region of the display region, and that has at least one substrate, a display element, a first electrode provided in the display region on the substrate to display an image, and a second electrode disposed to face the first electrode with the display element interposed therebetween, to apply a voltage according to an image to be displayed between the first electrode and the second electrode, the display panel comprising:
a peripheral electrode formed in the picture-frame region on the substrate in such a way as to cover at least a part of an electrical wiring line arranged in the picture-frame region on the substrate, the electrical wiring line being arranged in such a way as to face the second electrode with the display element interposed therebetween, the peripheral electrode being formed to face the electrical wiring line with an insulating film interposed between; and
a peripheral-electrode-giving-potential generating circuit that provides a potential to the peripheral electrode, the potential being determined according to a control signal provided from an external source, wherein
a light-shielding layer is not provided in the picture-frame region.

2. The display panel according to claim 1, wherein the peripheral electrode is formed in the picture-frame region on the substrate in such a way as to surround the display region.

3. The display panel according to claim 1, wherein the peripheral electrode is formed in such a way as to cover all of the electrical wiring line.

4. The display panel according to claim 1, wherein
the control signal is a binary signal, and
the peripheral-electrode-giving-potential generating circuit provides a potential having a predetermined potential difference from a potential provided to the second electrode, or a potential equal to the potential provided to the second electrode, to the peripheral electrode according to a value of the control signal.

5. The display panel according to claim 4, wherein
a first potential and a second potential are alternately provided to the second electrode every predetermined period, the first potential being a predetermined high-level potential and the second potential being a predetermined low-level potential, and
the peripheral-electrode-giving-potential generating circuit:
receives a first peripheral electrode potential setting signal having a potential equal to the second potential when the first potential is provided to the second electrode, and having a potential equal to the first potential when the second potential is provided to the second electrode; and a second peripheral electrode potential setting signal having a potential equal to the first potential when the first potential is provided to the second electrode, and having a potential equal to the second potential when the second potential is provided to the second electrode, and
provides the first peripheral electrode potential setting signal or the second peripheral electrode potential setting signal to the peripheral electrode according to the value of the control signal.

6. The display panel according to claim 1, wherein the first electrode is a pixel electrode to which a potential according to the image to be displayed is provided, the second electrode is a counter electrode provided to apply a voltage between the pixel electrode and the second electrode, and the display element is a liquid crystal element.

7. The display panel according to claim 1, wherein the first electrode is an anode electrode, the second electrode is a cathode electrode, and the display element is an organic electroluminescence element.

8. A display device comprising a display panel according to claim 1.

9. A display device comprising a display panel according to claim 2.

10. A display device comprising a display panel according to claim 3.

11. A display device comprising a display panel according to claim 4.

12. A display device comprising a display panel according to claim 5.

13. A display device comprising a display panel according to claim 6.

14. A display device comprising a display panel according to claim 7.
